(19) United States
(12) Patent Application Publication
(10) Pub. No.: US 2009/0166143 A1
(43) Pub. Date: Jul. 2, 2009

(54) DRIVE, PREFERABLY FOR SHIPS

(76) Inventors: Wolfgang Rieseberg, Hessisch Oldendorf (DE); Juergen Daus, Hehlen (DE); Christian Eschert, Helpsen (DE)

Correspondence Address: DARBY & DARBY P.C., P.O. BOX 770, Church Street Station, New York, NY, 10008-0770, US

(21) Appl. No.: 12/262,954

(22) Filed: Oct. 31, 2008

(30) Foreign Application Priority Data
Nov. 1, 2007 (DE) 10 2007 052 542.9

(51) Int. Cl. F16D 13/52

(52) U.S. Cl. 192/70.19

(57) ABSTRACT

A drive including a fixed housing, a shaft rotatably disposed in the housing, at least one hydraulic-fluid actuatable switching element, a supply of hydraulic fluid to the actuatable switching element, an inner body disposed on the shaft so as to co-rotate with the shaft and including an annular groove and a floating seal disposed between the fixed housing and the inner body. The supply of hydraulic fluid includes a feed channel that extends from radially outside through the fixed housing so as to discharge in the annular groove and extends inside the inner body to the hydraulic-fluid actuatable switching element.

### CROSS REFERENCE TO RELATED APPLICATIONS

Priority is claimed to German Patent Application No.10 2007 052 542.9, filed on Nov. 1, 2007. The entire disclosure of the application is incorporated by reference herein.

### FIELD

The invention relates to a drive, for example, for ships, the drive including a shaft and a hydraulic fluid actuatable switching element.

### BACKGROUND

Usual ships' drives comprise at least one drive motor, at least one propulsion element acting on the water and at least one torque-transmitting clutch disposed drivingly between the drive motor and the propulsion element. The clutch usually comprises a hydraulically actuatable or switchable multi-disk clutch which is disposed in a transmission with a drive shaft and a driven shaft. The drive shaft is drivingly connected to the drive motor and the driven shaft is drivingly connected to the propulsion element, in particular a propeller. The hydraulically actuatable multi-disk clutch makes the driving connection between the drive shaft and the driven shaft, directly or indirectly as desired. In known hydraulically actuatable multi-disk clutches for marine transmissions, hydraulic oil is fed to a cylinder or pressure chamber of the multi-disk clutch through an axial, and optionally further through a radial, bore in the shaft. As a result, a piston disposed in the cylinder or pressure chamber compresses the disk package of the multi-disk clutch and closes the multi-disk clutch. A torque can be transmitted by the frictional closure thus formed between the inner disks and the outer disks.

Drives in which the hydraulic oil is fed to the multi-disk clutch via, in some cases very long, axial bores incorporated in the drive shaft are disclosed, for example, in the patent specification U.S. Pat. No. 6,884,131 and U.S. Pat. No. 5,509,863 as well as in US 2007/0232161 Al. The entire disclosure of U.S. Pat. No. 6,884,131, U.S. Pat. No. 5,509,863 and US 2007/0232161 A1 are incorporated by reference herein.

Such designs with axial bores in the shaft are indeed suitable for higher pressures but have the disadvantage that they require a front-side rotary feed, optionally with a control unit, so that another usage of the shaft end, for example, for a power take-off is not possible. It is additionally disadvantageous that the long axial bores with the adjoining radial bores can only be produced at great expense.

However, other designs with a hydraulic oil supply which manages without axial bores in the shaft require shaft sealing rings for sealing. Such designs are not suitable for higher pressure. In addition, disadvantageously high friction losses can be observed at the shaft sealing rings.

### SUMMARY

It is an aspect of the present invention to provide a drive, preferably for ships, in which the hydraulic fluid can be supplied at high pressure to the switching element with high peripheral velocities at the same time, whereby the shaft end can still be used otherwise.

In an embodiment, the present invention provides a drive including a fixed housing, a shaft rotatably disposed in the housing, at least one hydraulic-fluid actuatable switching element, a supply of hydraulic fluid to the actuatable switching element, an inner body disposed on the shaft so as to co-rotate with the shaft and including an annular groove and a floating seal disposed between the fixed housing and the inner body. The supply of hydraulic fluid includes a feed channel that extends from radially outside through the fixed housing so as to discharge in the annular groove and extends inside the inner body to the hydraulic-fluid actuatable switching element.

### BRIEF DESCRIPTION OF THE DRAWINGS

The present invention will be described in greater detail on the basis of exemplary embodiments with reference to the figures in which:

FIG. 1 is a section of a drive train of a ship with a hydraulically actuatable multi-disk clutch; and

FIG. 2 is a section of a drive train of a ship with a hydraulically actuatable multi-disk clutch.

### DETAILED DESCRIPTION

In an embodiment, the invention provides that a floating seal is provided between the housing and an inner body disposed on the shaft, wherein the hydraulic fluid is supplied in the form of a feed channel which extends from radially outside through the housing and, depending on the form of the floating seal, optionally also through the floating seal, then discharges in an annular groove of the inner body co-rotating with the shaft and passes further inside the inner body, preferably parallel to the shaft axis, to the switching element.

By means of the floating seal, at least one gap is produced between seal and inner body and optionally at least one further gap between seal and housing through which the hydraulic medium escapes as a desired leakage flow.

Due to the design with a floating seal according to the invention, it is achieved that the high pressure of the hydraulic fluid required to actuate the switching element can be built up. In this case, the shaft end remains free for another use. An hydraulic fluid connection is advantageously no longer required there.

With the rotating shaft and a simultaneous supply of hydraulic fluid, preferably hydraulic oil, a preferably concentric annular gap is formed between the inner body and the seal, which exerts a blocking effect on the hydraulic fluid and reduces leakage. Very high pressures can be built up with only small leakage flow.

In an embodiment, the present invention provides that the switching element is a clutch, preferably a multi-disk clutch, wherein the multi-disk clutch can be hydraulically actuatable by means a hydraulic oil.

In an embodiment, the present invention provides that the housing and/or the floating seal can be configured in such a manner and/or suitable means are provided in such a manner that the floating seal can be held against axial displacement.

It is expediently provided that the housing and/or the floating seal are configured in such a manner and/or suitable means are disposed in such a manner that the floating seal does not co-rotate with the shaft.

The housing and/or the floating seal can be configured in such a manner and/or suitable means can be disposed in such a manner that tilting and/or displacements of the shaft can be compensated.

In an embodiment, the present invention provides that the floating seal is a sealing ring provided with a feed channel which can be mounted resiliently in the housing by means of two O-rings.

The O-rings can be disposed on both sides of the feed channel in corresponding receiving grooves of the housing and sealing ring. On the one hand, they can prevent the axial displacement of the sealing ring and on the other hand, they can prevent rotation of the sealing ring in the housing. Furthermore, the elasticity of the O rings has the result that possible tilting or displacements of the shaft are compensated.

In an embodiment, the present invention provides that the floating seal comprises two sealing rings which are disposed on either side of the annular groove of the inner body and which can surround the end of the housing comprising the feed channel, which points radially towards the annular groove of the inner body.

A retaining ring which abuts against the housing can be provided on the front side of each sealing ring pointing towards the annular groove, wherein sealing ring and retaining ring are preferably connected with at least one pin.

The retaining rings which are connected to the sealing rings by means of pins on the one hand prevent any axial displacement of the sealing rings and on the other hand prevent any co-rotation of the sealing rings with the shaft. The pins, which are inserted in a correspondingly aligned hole between sealing ring and retaining ring can additionally allow for a limited radial mobility of the sealing rings so that possible tilting or displacements of the shaft can be compensated and a concentric annular gap can be adjusted.

In the drive according to the present invention, the shaft diameter can be advantageously up to 500 mm, for example up to 300 mm, the oil pressure can be up to 30 bar and/or the rotational speeds can be higher than 100, for example higher than 500 rpm.

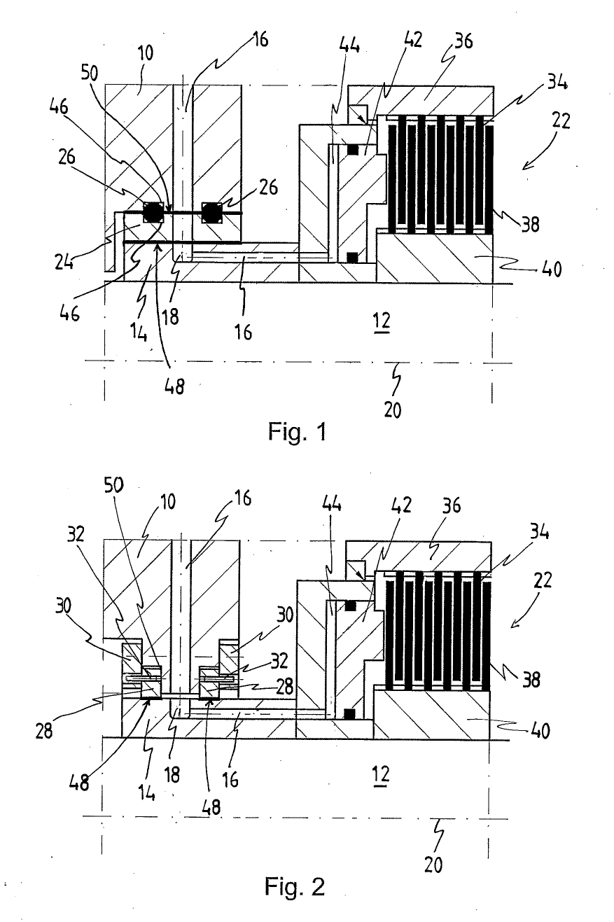

FIGS. 1 and 2 each show a section of a drive train of a ship. In this case, the drive comprises a fixed housing 10 having at least one shaft 12 mounted therein and at least one hydraulically actuatable multi-disk clutch 22.

Insofar as the same reference numerals are used in FIGS. 1 and 2, these should also designate the same parts.

The multi-disk clutch 22 comprises an outer disk carrier 36 carrying an outer disk 34, which is connected rotationally fixedly to a shaft not shown here. Inner disks 38 are disposed axially between the individual outer disks 34, which are fixed to an inner disk carrier 40 which in turn is connected rotationally fixedly to the shaft 12.

The disk package of the multi-disk clutch 22 formed substantially by the inner disks 38 and the outer disks 34 can be loaded with an axial force exertable by a piston 42, for transmission of a torque from the shaft 12 directly or indirectly to the shaft not shown here so that the said disks 34 and 38 enter into frictional closure with one another. This piston 42 is configured as an annular piston and is disposed axially displaceably in a pressure chamber 44.

For closing the multi-disk clutch 22, the piston can be exposed to a hydraulic actuating pressure that acts on the side of the piston 42 remote from the clutch disks in the pressure chamber 44. The actuating pressure or hydraulic pressure is generated by an oil pump not shown here.

The hydraulic oil required for switching is fed to the pressure chamber 44 as follows according to the invention.

The embodiment shown in FIG. 1 provides that a floating sealing ring 24 is provided between the housing 10 and the inner body 14 disposed on the shaft 12. Housing 10, inner body 14 and sealing ring 24 embrace the shaft 12 coaxially. According to the invention, the hydraulic oil is fed into pressure chamber 44 via a feed channel 16 which extends from radially outside through the housing 10 and further in alignment through the floating sealing ring 24, then discharges in an annular groove 18 of the inner body 14 co-rotating with the shaft 12 and then passes further inside the inner body 14 parallel to the shaft axis 20 into the pressure chamber 44.

The sealing ring 24 is mounted resiliently in the housing 10 by means of two O-rings 26, sealing ring 24 and housing 10 having corresponding receiving grooves 46.

The embodiment shown in FIG. 2 provides that a floating sealing ring in the form of two sealing rings 28 is provided between the housing 10 and the inner body 14 disposed on the shaft 12. Housing 10, inner body 14 and sealing rings 28 embrace the shaft 12 coaxially. According to the invention, the hydraulic oil is fed into the pressure chamber 44 via a feed channel 16 which extends from radially outside through the housing 10, discharges in an annular groove 18 of the inner body 14 co-rotating with the shaft 12 and then passes further inside the inner body 14 parallel to the shaft axis 20 into the pressure chamber 44.

As can be seen from FIG. 2, the floating seal comprises two sealing rings 28 which are disposed on either side of the annular groove 18 of the inner body 14 and surround the end of the housing 10 comprising the feed channel 16, which points radially towards the annular groove 18 of the inner body 14.

A retaining ring 30 also abutting against the housing 10 is provided on the front side of each sealing ring 28 not pointing towards the annular groove 18, wherein a pin 32 connecting each sealing ring 28 to the retaining ring 30 is preferably provided.

The housing 10 coaxially embracing the shaft 12 is configured at its radial end pointing towards the annular groove 18 of the inner body 14 on both sides of the feed channel 16 in such a manner that contact surfaces for the sealing rings 28 and further contact surfaces for the retaining rings 30 are formed.

Due to the floating seal, at least one gap 48 is produced between seal 24 or 28 and inner body 14 and optionally at least one further gap 50 between seal 24 and housing 10.

### REFERENCE LIST

10 Housing

12 Shaft

14 Inner body

16 Feed channel

18 Annular groove

20 Shaft axis

22 Multi-disc clutch

24 Sealing ring

26 O-ring

28 Sealing ring

30 Retaining ring

32 Pin

34 Outer disks

36 Outer disk carrier

38 Inner disks

40 Inner disk carrier

42 Piston

44 Pressure chamber

46 Receiving groove

48 Gap

50 Gap

1. A drive comprising:
a fixed housing;
a shaft rotatably disposed in the housing;
at least one hydraulic-fluid actuatable switching element;
a supply of hydraulic fluid to the actuatable switching element;
an inner body disposed on the shaft so as to co-rotate with the shaft and including an annular groove; and
a floating seal disposed between the fixed housing and the inner body;
wherein the supply of hydraulic fluid includes a feed channel that extends from radially outside through the fixed housing so as to discharge in the annular groove and extends inside the inner body to the hydraulic-fluid actuatable switching element.

2. The drive recited in claim 1, wherein the feed channel extends through the floating seal.

3. The drive recited in claim 1, wherein the feed channel extends inside the inner body parallel to an axis of the shaft.

4. The drive recited in claim 1, wherein the hydraulic-fluid actuatable switching element is a clutch.

5. The drive recited in claim 4, wherein the clutch is a multi-disk clutch.

6. The drive recited in claim 5, wherein the multi-disk clutch is hydraulically actuatable by a hydraulic oil.

7. The drive recited in claim 1, wherein at least one of the fixed housing and the floating seal is configured to hold the floating seal against axial displacement.

8. The drive recited in claim 1, wherein at least one of the fixed housing and the floating seal is configured to prevent co-rotation of the floating seal with the shaft.

9. The drive recited in claim 1, wherein at least one of the fixed housing and the floating seal is configured to compensate for at least one of tilting and displacement of the shaft.

10. The drive recited in claim 1, wherein the floating seal includes a sealing ring, and wherein the feed channel extends through the sealing ring.

11. The drive recited in claim 10, wherein the sealing ring is resiliently disposed in the housing by first and second O-rings.

12. The drive recited in claim 1, wherein the floating seal includes first and second sealing rings disposed on either side of the annular groove.

13. The drive recited in claim 12, wherein the first and second sealing rings are disposed on either side of the annular groove.

14. The drive recited in claim 13, wherein the first and second sealing rings surround an end of the fixed housing including the feed channel and facing radially towards the annular groove of the inner body.

15. The drive recited in claim 1, further comprising a respective retaining ring abutting the fixed housing disposed on a side of each of the first and second sealing rings facing away from the annular groove.

16. The drive recited in claim 15, further comprising a respective pin configured to connect each of the first and second sealing rings and the respective retaining ring.

17. The drive recited in claim 1, wherein a diameter of the shaft is up to 500 mm.

18. The drive recited in claim 17, wherein the diameter of the shaft is up to 300 mm.

19. The drive recited in claim 1, wherein a pressure of the hydraulic fluid is up to 30 bar.

20. The drive recited in claim 1, wherein a rotational speed of the shaft is higher than 100 rpm.

21. The drive recited in claim 20, wherein the rotational speed is higher than 500 rpm.

22. The drive recited in claim 1, wherein the shaft is a shaft of a ship.
